(19) United States
(12) Patent Application Publication
(10) Pub. No.: US 2013/0199207 A1
(43) Pub. Date: Aug. 8, 2013

(54) GAS TURBINE SYSTEM

(71) Applicants: Sushil Babu Mane, Bangalore (IN); Subodh Diwakar Deodhar, Bangalore (IN); Venkata Satyanarayana, Bangalore (IN)

(72) Inventors: Sushil Babu Mane, Bangalore (IN); Subodh Diwakar Deodhar, Bangalore (IN); Venkata Satyanarayana, Bangalore (IN)

(73) Assignee: GENERAL ELECTRIC COMPANY, Schenectady, NY (US)

(21) Appl. No.: 13/365,685

(22) Filed: Feb. 3, 2012

(51) Int. Cl. F02C 3/04; F01D 9/02

(52) U.S. Cl. 60/805; 415/208.1

(57) ABSTRACT

A gas turbine system including a compressor section, a combustor section and a turbine section, wherein the compressor section includes a first wheel and a second wheel having a center bore extending axially therethrough, and wherein the first wheel and the second wheel are relatively adjacent each other. Also included is a gap disposed between the first wheel and the second wheel, wherein airflow is directed radially inward within the gap toward the center bore of the second wheel with or without the help of impellers extending radially. The compressor section further includes an airflow manipulation device disposed within the gap, comprising of at least one or multiple vanes which may start in radial direction but extend at least partially into the center bore.

### BACKGROUND OF THE INVENTION

The subject matter disclosed herein relates to gas turbine systems, and more particularly to a compressor section of gas turbine systems.

Typically, in gas turbine systems, bucket supply secondary cooling airflow is extracted from a late stage of the compressor and directed radially inward through a flute, impellers, or a gap between compressor wheels. The airflow travels toward a center bore of the wheels. During the transition from the flute to the center bore, swirling vortices result and therefore an undesirably high pressure drop occurs within and proximate the center bore. A reduction of airflow swirling, and hence the pressure drop associated therewith would be advantageous.

### BRIEF DESCRIPTION OF THE INVENTION

According to one aspect of the invention, provided is a gas turbine system that includes a compressor section, a combustor section and a turbine section. The gas turbine system includes a first wheel and a second wheel having a center bore extending axially therethrough, wherein the first wheel and the second wheel are relatively adjacent each other. Also included is a gap disposed between the first wheel and the second wheel, wherein airflow is directed radially inward within the gap toward the center bore of the second wheel. The compressor section further includes an airflow manipulation device disposed within the gap and at least partially extending into the center bore, wherein the airflow manipulation device includes at least one slot extending axially into the center bore.

According to another aspect of the invention, a compressor section of a gas turbine system includes a front wheel. Also included is a rear wheel having a center bore extending axially therethrough and a plurality of impellers defining at least one impeller slot. Further included is a cavity disposed between the front wheel and the rear wheel. Yet further included is an air deflector having at least one vane that extends from proximate the cavity to an interior region of the center bore of the rear wheel. According to yet another aspect of the invention, a compressor section of a gas turbine system includes a front wheel and a rear wheel. Also included is an airflow manipulation device disposed between the front wheel and the rear wheel, wherein the airflow manipulation device comprises a plurality of vanes that extend into an axial center bore of the rear wheel, and wherein the airflow manipulation device is operably coupled to the front wheel or the rear wheel.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a region of a compressor section of a gas turbine system;

FIG. 2 is a perspective view of an air manipulation device disposed within a rear wheel of the compressor section;

FIG. 3 is a rear perspective view of the air manipulation device;

FIG. 4 is a side perspective view of the air manipulation device;

FIG. 5 is an elevational, cross-sectional view of the air manipulation device disposed between a front wheel and the rear wheel;

FIG. 6 is a schematic view of smooth airflow transition into a center bore of the rear wheel;

FIG. 7 is a schematic view of swirling airflow transition into the center bore of the rear wheel;

FIG. 8 is a perspective view of an embodiment of the air manipulation device attaching to the front wheel; and

FIG. 9 is a perspective view of another embodiment of the air manipulation device attaching to the front wheel.

The detailed description explains embodiments of the invention, together with advantages and features, by way of example with reference to the drawings.

### DETAILED DESCRIPTION OF THE INVENTION

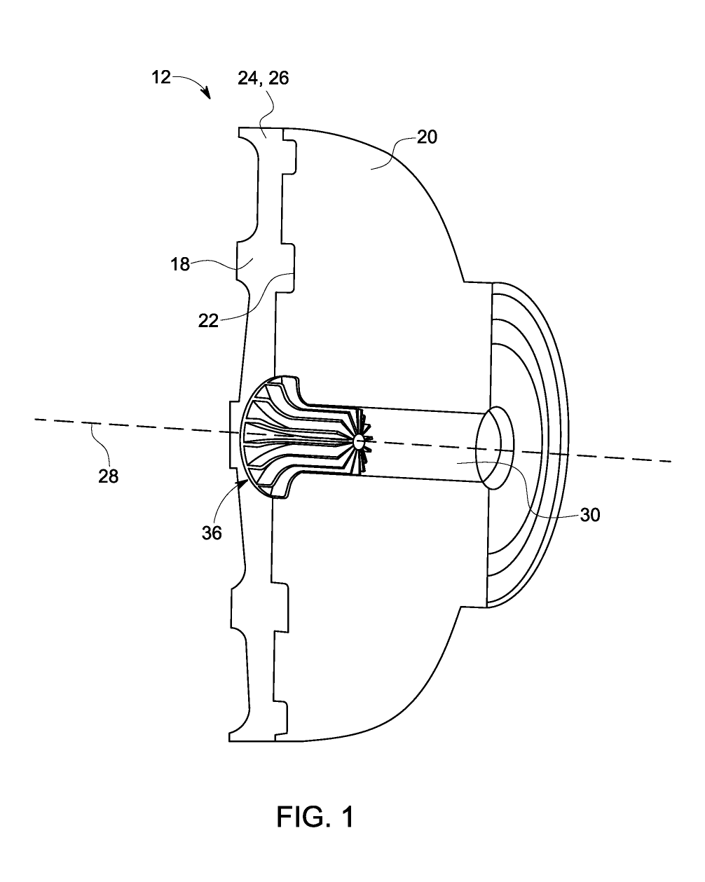

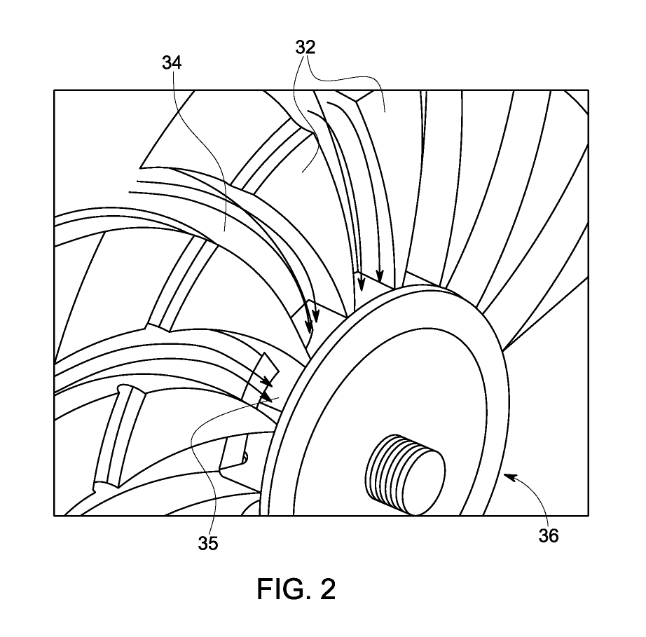

Referring to FIGS. 1 and 2, a gas turbine system 10 includes a compressor section 12 comprising a plurality of wheels for accelerating airflow through the gas turbine system and into a combustor section (not illustrated). The last two wheels that the airflow passes through are referred to as a front wheel 18 and rear wheel 20, respectively. In a common gas turbine system, the compressor section 12 may include a plurality of wheels which includes two rear wheels, thereby making the front wheel 18 correspond to the second to last wheel and the rear wheel 20 correspond to the rearmost wheel. Irrespective of the precise number of wheels disposed within the compressor section 12, the wheels referenced are with respect to the last two wheels of the compressor section 12.

The front wheel 18 and the rear wheel 20 are disposed within the compressor section 12 in a manner that forms an axial gap 22 between the two wheels, with the gap 22 extending radially inward from an outer radial location 24 that corresponds substantially to an outer diameter 26 of at least one of the wheels 18, 20. The gap 22 is configured to allow airflow from the outer radial location 24 toward a center axis 28 that extends axially through a center bore 30 of the rear wheel 20. The airflow passes through the center bore 30 and towards a turbine section containing a plurality of turbine wheels. Although the aforementioned description relates to the front wheel 18 and the rear wheel 20 being disposed within the compressor section 12, it is to be understood that the wheels referred to may be disposed anywhere in the gas turbine system 10, including but not limited to the turbine section 16.

The rear wheel includes a plurality of impellers 32 that define at least one impeller slot 34. The number of impeller slots 34 is a function of how many impellers 32 are present, with each impeller slot 34 defined by adjacent pairs of impellers 32. The impeller slots 34 extend radially inward from a location proximate the outer radial location 24 toward the center bore 30 and may take on a curved configuration, as defined by the geometry of the impellers 32. Typically, the impeller slots 34 will extend to a location proximate an inlet 35 of the center bore 30. Each impeller 32 extends axially forward, or upstream, to directly contact or come in close contact with the front wheel 18. In the case of the impellers 32 directly contacting or abutting the front wheel 18, the airflow is solely transferred radially inward through the impeller slots 34.

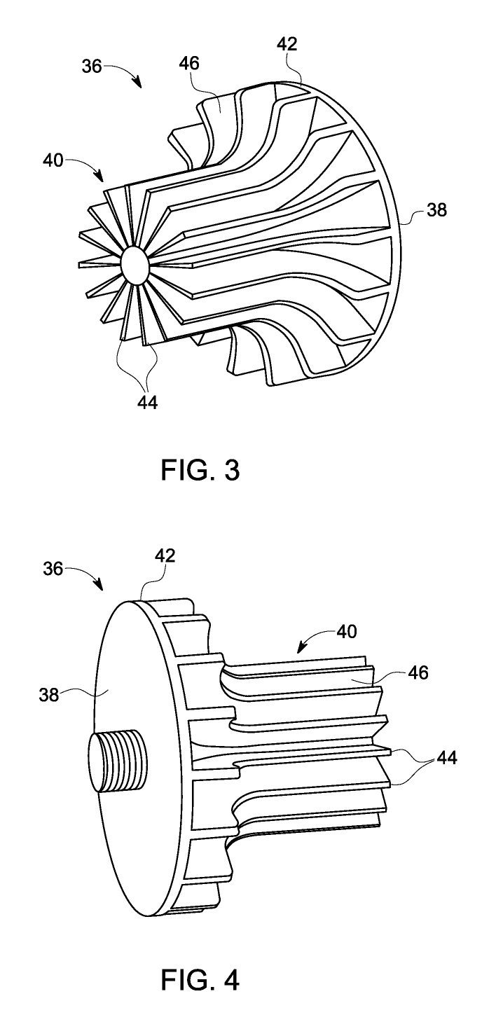

Referring now to FIGS. 3 and 4, an airflow manipulation device 36 having a base portion 38 and a vane portion 40 is disposed between the front wheel 18 and the rear wheel 20. The base portion 38 is substantially circular with an outer base diameter 42, but it is conceivable that other geometries may be employed. The base portion 38 is disposed to directly abut or come closely in contact with the front wheel 18. The vane portion 40 includes at least one, and typically a plurality of vanes 44 that extend from the base portion 38 axially rearward and into the center bore 30. The vanes 44 may extend radially inward as well, as the vanes 44 extend axially rearward into the center bore 30. The vanes 44 are aligned in such a manner that disposes a portion of the vanes 44 within the impeller slots 34, thereby imposing an extension of the impeller slots 34 directly into the center bore 30. Specifically, the vanes 44 form a plurality of vane slots 46 that function to serve as extensions of the impeller slots 34, such that airflow rushing radially inward through the impeller slots 34 smoothly transitions into the vane slots 46, and thereby the center bore 30. Alternatively, the vanes 44 may be adjustable, such that the vanes 44 extend to various regions, including up to or in to the impeller slots 34.

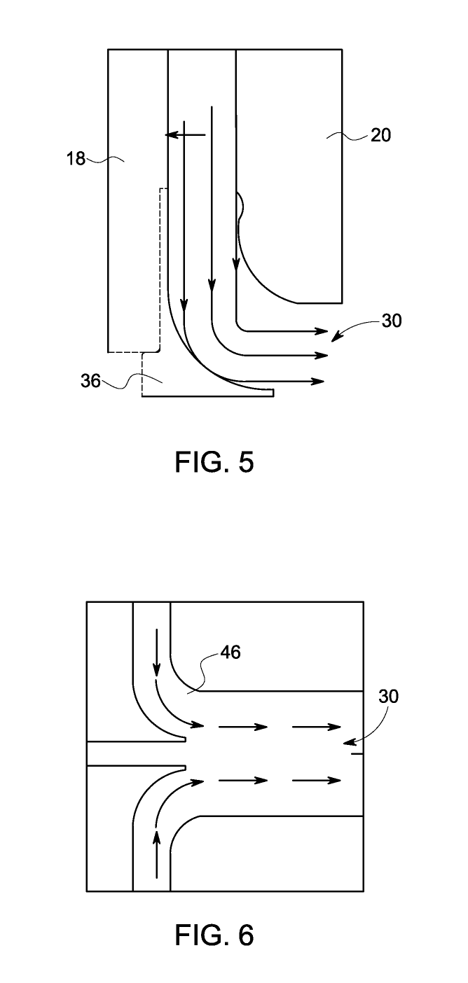

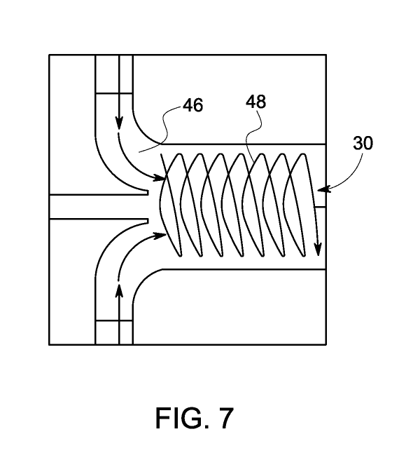

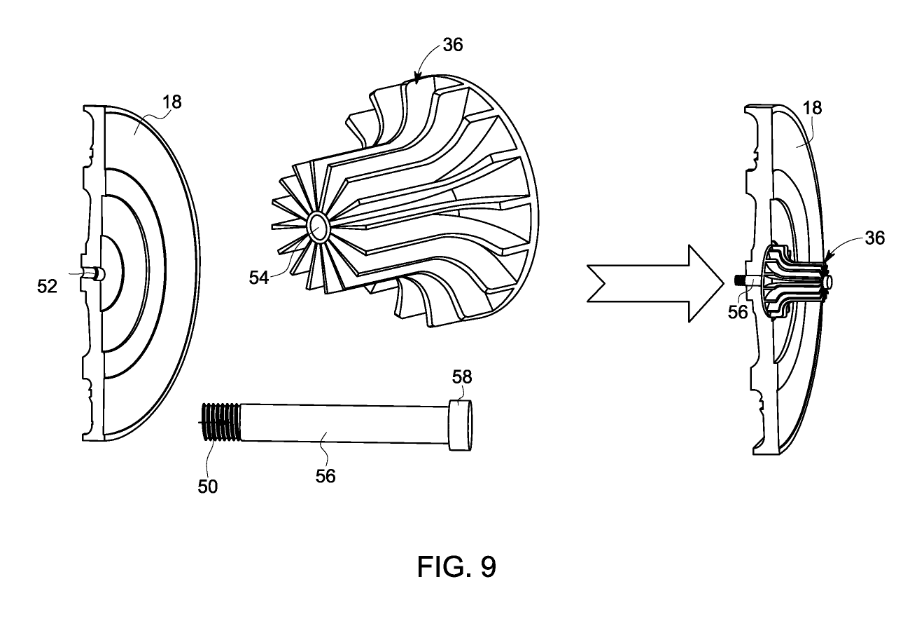

Referring to FIGS. 5-7, the effect of the airflow manipulation device 36, and more specifically the vane slots 46, is illustrated. A smooth deflection and transition of the airflow rushing inward toward the center bore 30 is established by the interaction of the vanes 44 and the impeller slots 34. This is in contrast to airflow that converts to a swirling vortex 48 in a system that does not extend vanes 44 into the center bore 30 (FIG. 9). Reduction of such swirling airflow advantageously reduces the pressure drop of the airflow as it passes into the center bore 30.

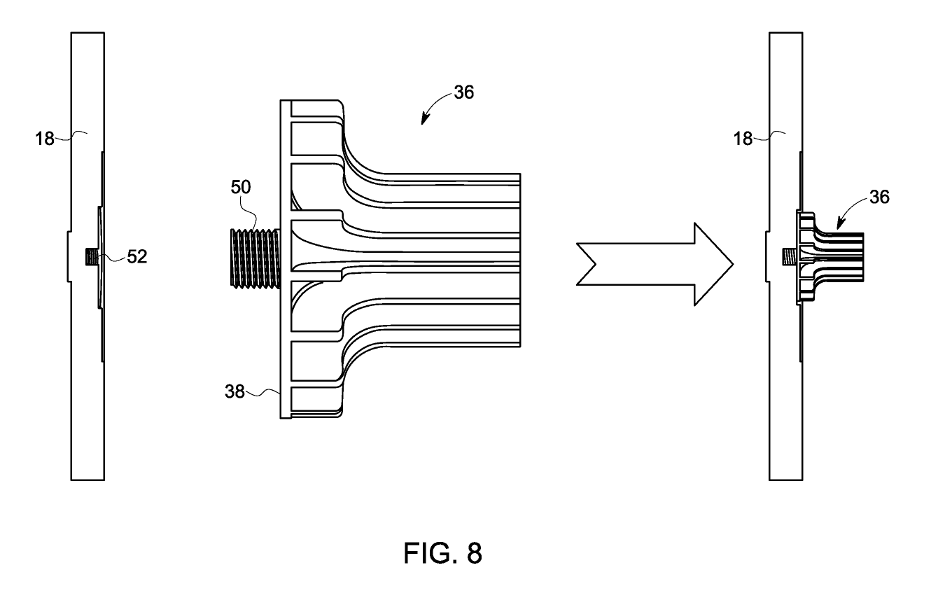

Referring now to FIGS. 8 and 9, attachment of the airflow manipulation device 36 to the compressor section 12 may be facilitated in a number of ways. As described above, it is to be appreciated that the airflow manipulation device 36 and the associated wheels 18, 20 referred to may be disposed in the turbine section 16 rather than the compressor section 12. A first embodiment includes a threaded fastener 50 that extends rearward from the base portion 38 of the airflow manipulation device 36. The front wheel 18 includes a corresponding threaded portion 52 that is configured to matably receive the threaded fastener 50, and thereby the airflow manipulation device 36. Another embodiment includes a center aperture 54 extending axially throughout the airflow manipulation device 36 and sized to receive a mechanical fastener 56, such as a stud therein. The mechanical fastener 56 includes a rear flange 58 that engages a region of the airflow manipulation device 36 proximate the center aperture 54 at a rearward location. Additionally, the front of the mechanical fastener 56 includes a threaded portion that matably engages the corresponding threaded portion 52 of the front wheel 18. The aforementioned embodiments are merely exemplary structures that facilitate attaching the airflow manipulation device 36 and it is conceivable that several other fasteners may be employed. For example, even press fit or interference fit of base portion 38 into the front wheel 18 can be used to secure the flow manipulation device 36 into place.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A gas turbine system having a compressor section, a combustor section and a turbine section, comprising:
a first wheel;
a second wheel having a center bore extending axially therethrough, wherein the first wheel and the second wheel are relatively adjacent each other;
a gap disposed between the first wheel and the second wheel, wherein airflow is directed radially inward within the gap toward the center bore of the second wheel; and
an airflow manipulation device disposed within the gap and at least partially extending into the center bore, wherein the airflow manipulation device includes at least one vane extending axially into the center bore.

2. The gas turbine system of claim 1, wherein the second wheel is located axially rearward of the first wheel.

3. The gas turbine system of claim 2, wherein at least one of the first wheel and the second wheel includes a plurality of impeller blades defining a plurality of impeller slots.

4. The gas turbine system of claim 3, the airflow manipulation device comprising:
a base portion having an outer diameter; and
a vane portion that includes a plurality of vanes.

5. The gas turbine system of claim 4, wherein the plurality of vanes extend from proximate the outer diameter of the base portion radially inward and axially rearward into the center bore.

6. The gas turbine system of claim 4, wherein at least one of the plurality of vanes adjustably extends up to or in to one of the plurality of impeller slots.

7. The gas turbine system of claim 1, wherein the airflow manipulation device is operably coupled to the first wheel.

8. The gas turbine system of claim 7, wherein the airflow manipulation device is fixed directly to the first wheel. 9. The gas turbine system of claim 7, wherein the airflow manipulation device is indirectly coupled to the first wheel by a mechanical fastener.

10. The gas turbine system of claim 1, wherein the first wheel and the second wheel are disposed within the compressor section.

11. The gas turbine system of claim 1, wherein the first wheel and the second wheel are disposed within the turbine section.

12. A compressor section of a gas turbine system comprising:
a front wheel;
a rear wheel having a center bore extending axially therethrough wherein at least one of the front wheel and the rear wheel includes a plurality of impellers defining at least one impeller slot;
a cavity disposed between the front wheel and the rear wheel; and
an air deflector having at least one vane that extends from proximate the cavity to an interior region of the center bore of the rear wheel.

13. The compressor section of a gas turbine system of claim 12, wherein the air deflector comprises:
a base portion having an outer diameter; and
a vane portion that includes a plurality of vanes.

14. The compressor section of a gas turbine system of claim 13, wherein the plurality of vanes extend from proximate the outer diameter of the base portion radially inward and axially rearward into the center bore.

15. The compressor section of a gas turbine system of claim 12, wherein the at least one vane adjustably extends up to or in to the at least one impeller slot.

16. The compressor section of a gas turbine system of claim 12, wherein the air deflector is fixed directly to the front wheel.

17. The compressor section of a gas turbine system of claim 12, wherein the air deflector is indirectly coupled to the front wheel by a mechanical fastener.

18. A compressor section of a gas turbine system comprising:
a front wheel;
a rear wheel; and
an airflow manipulation device disposed between the front wheel and the rear wheel, wherein the airflow manipulation device comprises a plurality of vanes that extend into an axial center bore of the rear wheel, and wherein the airflow manipulation device is operably coupled to at least one of the front wheel and the rear wheel.

19. The compressor section of a gas turbine system of claim 18, wherein at least one of the front wheel and the rear wheel includes a plurality of impeller blades defining a plurality of impeller slots.

20. The compressor section of a gas turbine system of claim 19, wherein the airflow manipulation device comprises:
a base portion having an outer diameter; and
a vane portion.
